(19) United States
(12) Patent Application Publication
(10) Pub. No.: US 2011/0219599 A1
(43) Pub. Date: Sep. 15, 2011

(54) Systems, Devices, and/or Methods for Fabricated Panels

(76) Inventors: Les Gonda, Keswick, VA (US); Kerry Elzey, Barboursville, VA (US); Doug Long, Charlottesville, VA (US)

(21) Appl. No.: 13/043,181

(22) Filed: Mar. 8, 2011

Related U.S. Application Data
(60) Provisional application No. 61/312,727, filed on Mar. 11, 2010.

(51) Int. Cl. B23P 11/00; B23P 19/00

(52) U.S. Cl. 29/428; 29/700

(57) ABSTRACT

Certain exemplary embodiments can provide a method, which can comprise forming a device. The device can comprise a panel, which can comprise a pair of face sheets, a first set of corrugated ribbons, and a second set of corrugated ribbons. The sets of corrugated ribbons can be adapted to maintain a spacing between the pair of opposing face sheets.

### CROSS-REFERENCES TO RELATED APPLICATIONS

This application claims priority to, and incorporates by reference herein in its entirety, pending U.S. Provisional Patent Application Ser. No. 61/312,727 (Attorney Docket No. 1010-004), filed 11 Mar. 2010.

### BRIEF DESCRIPTION OF THE DRAWINGS

A wide variety of potential embodiments will be more readily understood through the following detailed description of certain exemplary embodiments, with reference to the accompanying exemplary drawings in which:

FIG. 1 is a perspective view of an exemplary embodiment of a system 1000; and

FIG. 2 is a flowchart of an exemplary embodiment of a method 2000.

### DETAILED DESCRIPTION

Certain exemplary embodiments can provide a method, which can comprise forming a device. The device can comprise a panel, which can comprise a pair of face sheets, a first set of corrugated ribbons, and a second set of corrugated ribbons. The sets of corrugated ribbons can be adapted to maintain a spacing between the pair of opposing face sheets.

Certain exemplary embodiments provide a flat and/or curved multifunctional lightweight sandwich panel fabricated using a flexible ribbon core structure and/or a method for manufacturing such a panel.

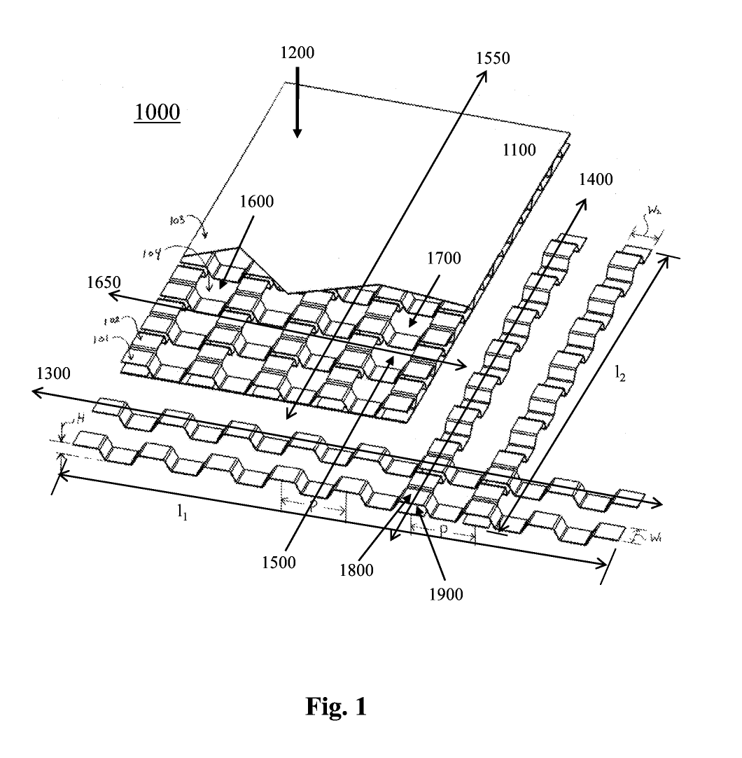

FIG. 1 is a perspective view of an exemplary embodiment of a device and/or system 1000, which can comprise a substantially planar, single, or multi-curved panel 1100, which can be a sandwich panel. Panel 1100 can be fabricated using a flexible ribbon core structure, which can comprise a first set of corrugated ribbons 101 and a second set of corrugated ribbons 102. Each ribbon of first set of corrugated ribbons 101 can define:
a longitudinal axis 1300;
a length l₁;
a height H, height H of each of first set of corrugated ribbons 101 can be less than length l₁ of first set of corrugated ribbons 101;
a width w₁, width w₁ of first set of corrugated ribbons 101 can be less than length l₁ of first set of corrugated ribbons 101; and/or
a period, P, length l₁ of first set of corrugated ribbons 101 can be greater than twice period P of first set of corrugated ribbons 101.

Each ribbon of second set of corrugated ribbons 102 can define:
a longitudinal axis 1400, each longitudinal axis 1400 of each ribbon of second set of corrugated ribbons 102 of panel 1100 can be substantially perpendicular to each longitudinal axis 1300 of each ribbon of first set of corrugated ribbons 102 of panel 1100;
a length l₂;
a height H, height H of each of second set of corrugated ribbons 102 can be less than length l₂ of second set of corrugated ribbons 102;
a width w₂, width w₂ of second set of corrugated ribbons 102 can be less than length l₂ of second set of corrugated ribbons 102; and/or
a period, P, length l₂ of second set of corrugated ribbons 102 can be greater than twice period P of second set of corrugated ribbons 102.

Each longitudinal axis 1400 of each ribbon of the second set of corrugated ribbons 102 of panel 1100 can be substantially perpendicular to each longitudinal axis 1300 of each ribbon of the first set of corrugated ribbons 101 of the panel.

System 1000 can comprise a first face sheet 103 and a second face sheet 104, which can be substantially opposing face sheets when operatively installed as a part of panel 1100. First set of corrugated ribbons 101 and/or second set of corrugated ribbons 102 can be releasably and/or fixedly attached to first face sheet 103 and/or second face sheet 104 and, thereby, can be sandwiched between first face sheet 103 and second face sheet 104. For example, first set of corrugated ribbons 101 and second set of corrugated ribbons 102 can be fixedly attached to first face sheet 103 and/or second face sheet 104 via adhesive bonding, welding, brazing, and/or via any other suitable bonding method. Thereby, first set of corrugated ribbons 101 and second set of corrugated ribbons 102 can be sandwiched between first face sheet 103 and second face sheet 104.

Raised portions 1800 of each ribbon of first set of corrugated ribbons 101 can interlock with a corresponding recessed portion 1900 of ribbons of second set of corrugated ribbons 102. Via interaction with raised portions 1800 of each ribbon of first set of corrugated ribbons 101 with second set of corrugated ribbons 102, second set of corrugated ribbons 102 can be adapted to restrain motion of each of first set of corrugated ribbons 101 relative to second set of corrugated ribbons 102:
in a direction that is substantially parallel to longitudinal axes 1300 of each ribbon of first set of corrugated ribbons 101; and/or
in a direction that is substantially parallel to longitudinal axes 1400 of each ribbon of second set of corrugated ribbons 102.

The sets of corrugated ribbons can be adapted to
maintain a spacing between pair of face sheets 103-104; and/or
increase resistance of panel 1100 to a reduction in spacing between pair of opposing face sheets 103-104 from a force 1200 applied to a surface of one of pair of opposing face sheets 103-104.

When operatively attached to first face sheet 103 and/or second face sheet 104, longitudinal axes 1300 of each of first set of corrugated ribbons 101 can be substantially perpendicular to longitudinal axes 1400 of each of second set of corrugated ribbons 102.

The panel, via the pair of opposing face sheets and the sets of corrugated ribbons, can define:
a first plurality of channels 1500, each of which defines a longitudinal axis 1550; and
a second plurality of channels 1600, each of which defines a longitudinal axis 1650, each longitudinal axis 1550 of each of first plurality of channels 1500 can be substantially perpendicular to each longitudinal axis 1650 of each of second plurality of channels 1600.

First plurality of channels 1500 and/or second plurality of channels 1600 can be adapted to transfer heat from panel 1100 via a heat transfer fluid 1700.

First set of corrugated ribbons 101 and/or second set of corrugated ribbons 102 can be adapted to transfer electrical energy from panel 1100.

First face sheet 103, second face sheet 104, first set of corrugated ribbons 101 and/or second set of corrugated ribbons 102 can be fabricated from metal, plastic, or other suitable material. In certain exemplary embodiments, each of first face sheet 103, second face sheet 104, first set of corrugated ribbons 101 and/or second set of corrugated ribbons 102 can be made of substantially identical materials. In other exemplary embodiments, each of first face sheet 103, second face sheet 104, first set of corrugated ribbons 101 and/or second set of corrugated ribbons 102 can be made of different materials.

First set of corrugated ribbons 101 can define a characteristic period, P a height H, and a width W1. Similarly, second set of corrugated ribbons 102 can define a characteristic period P, a height H, and a width W2. For example, characteristic period P can be any suitable dimension, such as in inches, 0.375, 0.5, 0.81, 0.993, 1, 1.07, 1.5, 2.06, 4.967, 5.3, 7, 8.937, 10.012, 12, and/or any value or subrange therebetween. Height H can be any suitable dimension, such as in inches, 0.1, 0.245, 0.25, 0.495, 0.81, 0.993, 1.12, 1.764, 2.5, 2.86, 3.459, 5.32, 6, and/or any value or subrange therebetween. Widths W1 and/or W2 can be any suitable dimension, such as in inches, 0.075, 0.234, 0.35, 0.446, 0.913, 1.387, 1.75, 2.5, 2.86, 3.27, 3.459, 4 and/or any value or subrange therebetween.

A single or multi-curved panel can be fabricated via forming and/or fixturing to obtain a desired face sheet curvature. First set of corrugated ribbons 101 and/or second set of corrugated ribbons 102 can be bonded to such a curved face sheet, after which, a top face sheet can be applied, bonded, formed, and/or fixtured in place.

Corrugations of first set of corrugated ribbons 101 and/or second set of corrugated ribbons 102 can be created via rolling a substantially planar ribbon material through a set of rolls.

When operatively attached to first face sheet 103, second face sheet 104, corrugations of first set of corrugated ribbons 101 can overlap and/or interlock with corrugations of second set of corrugated ribbons 102. For example, when operatively coupled to at least one of first face sheet 103 and second face sheet 104:
a raised portion 1800 of a ribbon of first set of corrugated ribbons 101 can be adapted to at least partially overlap a recessed portion 1900 of a ribbon of second set of corrugated ribbons 102;
via interaction between the ribbon of first set of corrugated ribbons 101 and the ribbon of second set of corrugated ribbons 102, the ribbon of first set of corrugated ribbons 101 can restrain motion of the ribbon of second set of corrugated ribbons 102 in a direction that is substantially parallel to longitudinal axis 1400 of the ribbon of second set of corrugated ribbons 102;
via interaction between the ribbon of first set of corrugated ribbons 101 and the ribbon of second set of corrugated ribbons 102, the ribbon of first set of corrugated ribbons 101 can restrain motion of the ribbon of second set of corrugated ribbons 102 in a direction that is substantially parallel to longitudinal axis 1300 of the ribbon of first set of corrugated ribbons 101;
first set of corrugated ribbons 101 and second set of corrugated ribbons 102 can be adapted to define and/or maintain a spacing between first face sheet 103 and second face sheet 104 such that surfaces of first face sheet 103 and second face sheet 104 are substantially parallel and/or substantially non-parallel;
first set of corrugated ribbons 101 and second set of corrugated ribbons 102 can be adapted to resist a reduction in the spacing from compressive forces applied to first face sheet 103 and/or second face sheet 104;
longitudinal axes 1300 defined by each of first set of corrugated ribbons 101 are substantially parallel to each other;
longitudinal axes 1400 defined by each of second set of corrugated ribbons 102 are substantially parallel to each other and substantially perpendicular to each longitudinal axis 1300 defined by each of first set of corrugated ribbons 101;
first plurality of channels 1500 are defined by surfaces of first face sheet 103 and second face sheet 104 and a plurality of raised portions 1800 of at least one of first set of corrugated ribbons 101 and second set of corrugated ribbons 102;
a second plurality of channels 1600 are defined by surfaces of first face sheet 103 and second face sheet 104 and a plurality of recessed portions 1900 of at least one of first set of corrugated ribbons 101 and second set of corrugated ribbons 102;
longitudinal axes 1550 of the first plurality of channels 1500 can be substantially perpendicular to longitudinal axes 1650 of the second plurality of channels 1600;
each of the plurality of channels can be adapted to transfer heat via a heat transfer fluid, the heat transfer fluid can be air, water, hydrogen, an inert gas, sulfur hexafluoride, steam, ethylene glycol, diethylene glycol, propylene glycol, betaine, polyalkylene glycol, mineral oil, silicone oil, fluorocarbon oil, transformer oil, a liquid fusible alloy, freon, a halomethane, a nanofluid, and/or any combination thereof; and/or
system 1000 can be adapted to conduct electricity between an electrical source and an electrical load.

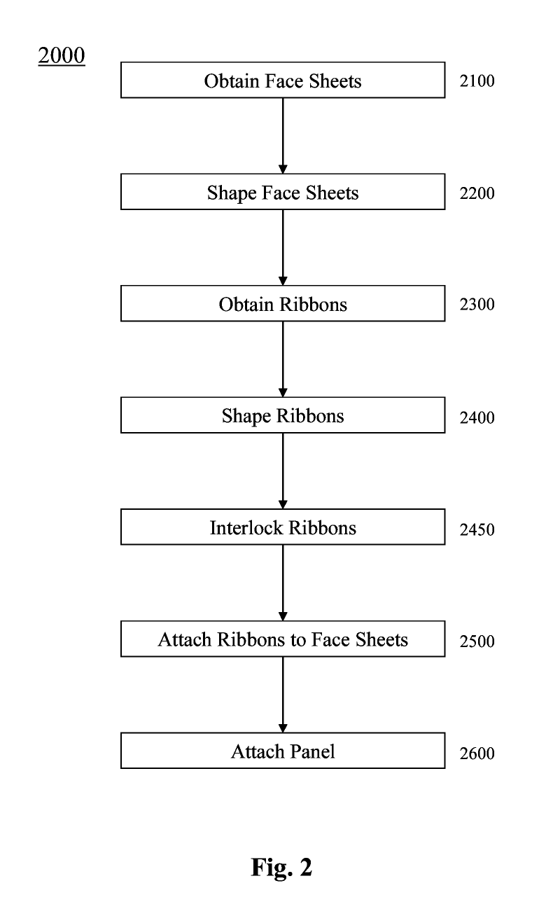

FIG. 2 is a flowchart of an exemplary embodiment of a method 2000. At activity 2100, face sheets can be obtained. In certain exemplary embodiments, the face sheets can be a pair of substantially planar face sheets. The face sheets can be made of a suitable material, such as a formable metal, plastic, or other suitable material.

At activity 2200, the face sheets can be shaped. The face sheets can be rolled, formed, bent, and/or shaped in a metal break in order to obtain a desired contour. The desired contour can comprise a compound curvature. The face sheets can be rolled such that each of the pair of opposing face sheets comprises a compound curvature.

At activity 2300, ribbons can be obtained. In certain exemplary embodiments, the ribbons can be substantially planar when obtained and can be shaped and/or formed to define corrugations. The corrugations can be spaced and of a sufficient size to overlap and/or interlock with other ribbons when operatively coupled to one or more of the face sheets.

At activity 2400, the ribbons can be formed and/or shaped. In certain exemplary embodiments, the ribbons can be rolled between two rollers. The rollers can be adapted to form corrugations in the ribbons. Each ribbon can define a longitudinal axis.

At activity 2450, the first set of ribbons can be interlocked with the second set of ribbons. The interlocking can be such that a raised portion of each ribbon of the first set of corrugated ribbons is interlocked with a corresponding recessed portion of ribbons of the second set of corrugated ribbons. Via interaction with the raised portion of each ribbon of the first set of corrugated ribbons with the second set of corrugated ribbons, the second set of corrugated ribbons can be adapted to restrain motion of each of the first set of corrugated ribbons relative to the second set of corrugated ribbons:
in a first direction that is substantially parallel to the longitudinal axes of each ribbon of the first set of corrugated ribbons; and/or
in a second direction that is substantially parallel to the longitudinal axes of each ribbon of the second set of corrugated ribbons.

At activity 2500, the ribbons, which can comprise a first set of corrugated ribbons and a second set of corrugated ribbons, can be releasably and/or fixedly attached to the face sheets. For example the ribbons can be attached to the face sheets via adhesive bonding, welding, brazing, and/or any other suitable fastening means. The face sheets can be operatively coupled to the ribbons such that:
the face sheets are opposing face sheets;
surfaces of the pair of face sheets are substantially parallel;
surfaces of the pair of face sheets are substantially non-parallel; and/or
the face sheets are substantially non-planar and define a radius of curvature that is less than approximately 2 meters.

The sets of corrugated ribbons can be adapted to maintain a spacing between the pair of face sheets. The sets of corrugated ribbons can be adapted to increase resistance of the panel to a reduction in spacing between the pair of opposing face sheets from a force applied to a surface of one of the pair of opposing face sheets. Each longitudinal axis of each ribbon of the second set of corrugated ribbons of the panel can be substantially perpendicular to each longitudinal axis of each ribbon of the first set of corrugated ribbons of the panel.

The panel, via the pair of opposing face sheets and the sets of corrugated ribbons, can define a first plurality of channels, each of which can define a longitudinal axis, and a second plurality of channels, each of which can define a longitudinal axis. Each longitudinal axis of each of the first plurality of channels can be substantially perpendicular to each longitudinal axis of each of the second plurality of channels.

At activity 2600, a panel comprising the face sheets and the ribbons can be attached to a device and/or system. In certain exemplary embodiments, the system can comprise one or more solar panels, floor structures, walls, vehicular surfaces, and/or building surfaces, etc. The panel can be adapted to provide heat transfer and/or electrical transfer between surfaces. For example, in certain exemplary solar cell applications, a first face sheet of the panel can be adapted to transfer electricity while a second face sheet of the panel transfers heat from the solar cell. The panel can be adapted to reduce heat transfer from a surface in contact with the panel as compared to a solid mass of material of a comparable size.

The first plurality of channels and/or the second plurality of channels can be adapted to transfer heat from the panel via a heat transfer fluid. The first set of corrugated ribbons and/or the second set of corrugated ribbons can be adapted to transfer electrical energy from the panel.

### DEFINITIONS

When the following terms are used substantively herein, the accompanying definitions apply. The right to redefine these terms during the prosecution of this application or any application claiming priority hereto is expressly reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, deed, function, step, and/or process and/or a portion thereof.
adapted to—suitable, fit, and/or capable of performing a specified function.
and/or—either in conjunction with or in alternative to.
apparatus—an appliance or device for a particular purpose.
attach—to fasten, secure, couple, affix, join, and/or connect.
can—is capable of, in at least some embodiments.
channel—a tubular and/or trough-shaped passage, substantially enclosed and/or bounded on at least two sides, through which a fluid can pass.
compound curvature—a surface contour that is characterized by a plurality of curved surfaces that are joined at a point of tangency and are located on a same side of a common tangent; wherein, radii of the curved surfaces have different values.
comprising—including but not limited to.
connect—to join or fasten together.
corresponding—associated in a spatial relationship.
corrugate—to shape into alternating grooves and ridges.
coupleable—capable of being joined, connected, and/or linked together.
coupling—linking in some fashion.
define—to establish the meaning, relationship, outline, form, and/or structure of; and/or to precisely and/or distinctly describe and/or specify.
device—a machine, manufacture, and/or collection thereof.
face sheet—a layer of material that is relatively broad compared to its thickness and is adapted to form a panel when covering a set of corrugated ribbons.
force—an influence on a body or system, producing or tending to produce a change in movement or in shape or other effects.
form—to make, produce, construct, and/or give shape to.
fixedly—fastened, attached, and/or placed so as to be firm and substantially non-removable without some level of destruction.
fixture—to securing a face sheet onto or inside a form and/or mould.
generate—to create, produce, give rise to, and/or bring into existence.
install—to connect or set in position and prepare for use.
interlock—to interweave or interlace, one with another.
longitudinal axis—a straight line defined parallel to an object's length and passing through a centroid of the object.
may—is allowed and/or permitted to, in at least some embodiments.
method—a process, procedure, and/or collection of related activities for accomplishing something.
opposing—opposite; against; being the other of two complementary or mutually exclusive things; placed or located opposite, in contrast, in counterbalance, and/or across from something else and/or from each other.
panel—a distinct section or component of something that comprises and is formed via a sheet of material.
parallel—of, relating to, or designating two or more planes that do not intersect.
period—a distance between centerlines of successive corrugations of an object.
perpendicular—intersecting at or forming substantially right angles.
planar—shaped as a substantially flat two-dimensional surface.
plurality—the state of being plural and/or more than one.
predetermined—established in advance.
provide—to furnish, supply, give, and/or make available.
radius of curvature—the radius of a circle the curvature of which is equal to that of the given curve at that point.
raised—elevated relative to another portion of an object.
recessed—indented relative to another portion of an object.
reduction—a diminishment in distance and/or size.
relative—considered with reference to and/or in comparison to something else.
releasably—capable of being substantially non-destructively freed from something that binds, fastens, or holds back.
repeatedly—again and again; repetitively.
request—to express a desire for and/or ask for.
resistance—the capacity to withstand a force.
ribbon—a strip of material that is narrow relative to its length.
roll—to form and/or deform via one or more rollers
set—related plurality of predetermined elements; and/or one or more distinct items and/or entities having a specific common property or properties.
space—to set apart or separate by a predetermined distance.
substantially—to a great extent or degree.
support—to bear the weight of, especially from below.
surface—an outer boundary of an object or a material layer constituting or resembling such a boundary.
system—a collection of mechanisms, devices, machines, articles of manufacture, processes, data, and/or instructions, the collection designed to perform one or more specific functions.
via—by way of and/or utilizing.

### Note

Still other practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A method comprising a plurality of activities, comprising:
forming a device, said device comprising a panel, said panel comprising:
a pair of opposing face sheets;
a first set of corrugated ribbons, each ribbon of said first set of corrugated ribbons defining a longitudinal axis; and
a second set of corrugated ribbons, said sets of corrugated ribbons adapted to maintain a spacing between said pair of opposing face sheets, said sets of corrugated ribbons adapted to increase resistance of said panel to a reduction in spacing between said pair of opposing face sheets from a force applied to a surface of one of said pair of opposing face sheets, each ribbon of said second set of corrugated ribbons defining a longitudinal axis, each longitudinal axis of each ribbon of said second set of corrugated ribbons of said panel substantially perpendicular to each longitudinal axis of each ribbon of said first set of corrugated ribbons of said panel;
said panel, via said pair of opposing face sheets and said sets of corrugated ribbons, defining:
a first plurality of channels, each of which defines a longitudinal axis; and
a second plurality of channels, each of which defines a longitudinal axis, each longitudinal axis of each of said first plurality of channels substantially perpendicular to each longitudinal axis of each of said second plurality of channels.

2. The method of claim 1, further comprising:
interlocking said first set of corrugated ribbons with said second set of corrugated ribbons.

3. The method of claim 1, further comprising:
interlocking said first set of corrugated ribbons with said second set of corrugated ribbons such that a raised portion of each ribbon of said first set of corrugated ribbons is interlocked with a corresponding recessed portion of ribbons of said second set of corrugated ribbons, via interaction with said raised portion of each ribbon of said first set of corrugated ribbons with said second set of corrugated ribbons, said second set of corrugated ribbons adapted to restrain motion of each of said first set of corrugated ribbons relative to said second set of corrugated ribbons:
in a first direction that is substantially parallel to said longitudinal axes of each ribbon of said first set of corrugated ribbons; and
in a second direction that is substantially parallel to said longitudinal axes of each ribbon of said second set of corrugated ribbons.

4. The method of claim 1, further comprising:
fixedly attaching said first set of corrugated ribbons to said panel.

5. The method of claim 1, further comprising:
releasably attaching said first set of corrugated ribbons to said panel.

6. The method of claim 1, further comprising:
forming said first set of corrugated ribbons from a substantially planar ribbon material via a set of rolls.

7. The method of claim 1, further comprising:
rolling said pair of opposing face sheets such that each of said pair of opposing face sheets comprises a compound curvature.

8. The method of claim 1, wherein:
surfaces of said pair of opposing face sheets are substantially parallel.

9. The method of claim 1, wherein:
surfaces of said pair of opposing face sheets are substantially non-parallel.

10. The method of claim 1, wherein:
said first plurality of channels is adapted to transfer heat from said panel via a heat transfer fluid.

11. The method of claim 1, wherein:
said second plurality of channels is adapted to transfer heat from said panel via a heat transfer fluid.

12. The method of claim 1, wherein:
said first set of corrugated ribbons is adapted to transfer electrical energy from said panel.

13. The method of claim 1, wherein:
said second set of corrugated ribbons is adapted to transfer electrical energy from said panel.

14. The method of claim 1, wherein:
said pair of opposing face sheets are substantially non-planar and define a radius of curvature that is less than approximately 2 meters.

15. A system comprising:
a device comprising a panel, said panel comprising a pair of opposing face sheets sandwiching a plurality of corrugated ribbons therebetween, wherein the plurality of corrugated ribbons comprises a first set of corrugated ribbons and a second set of corrugated ribbons, said sets of corrugated ribbons adapted to maintain a spacing between said pair of opposing face sheets, said sets of corrugated ribbons adapted to increase resistance of said panel to a reduction in spacing between said pair of opposing face sheets from a force applied to a surface of one of said pair of opposing face sheets, each ribbon of said sets of corrugated ribbons defining a longitudinal axis, each longitudinal axis of each ribbon of said second set of corrugated ribbons of said panel substantially perpendicular to each longitudinal axis of each ribbon of said first set of corrugated ribbons of said panel, said panel, via said pair of opposing face sheets and said sets of corrugated ribbons, defining:
a first plurality of channels, each of which defines a longitudinal axis; and
a second plurality of channels, each of which defines a longitudinal axis, each longitudinal axis of each of said first plurality of channels substantially perpendicular to each longitudinal axis of each of said second plurality of channels.

16. The system of claim 15, wherein:
said first plurality of channels is adapted to transfer heat from said panel via a heat transfer fluid.

17. The system of claim 15, wherein:
said second plurality of channels is adapted to transfer heat from said panel via a heat transfer fluid.

18. The system of claim 15, wherein:
said first set of corrugated ribbons is adapted to transfer electrical energy from said panel.

19. The system of claim 15, wherein:
said second set of corrugated ribbons is adapted to transfer electrical energy from said panel.

20. A method comprising a plurality of activities, comprising:
forming a device, said device comprising a panel, said panel comprising:
a pair of opposing face sheets;
a first set of corrugated ribbons, each ribbon of said first set of corrugated ribbons defining:
a longitudinal axis;
a length;
a height, said height of each of said first set of corrugated ribbons less than said length of said first set of corrugated ribbons;
a width, said width of said first set of corrugated ribbons less than said length of said first set of corrugated ribbons; and
a period, said length of said first set of corrugated ribbons greater than twice said period of said first set of corrugated ribbons;
a second set of corrugated ribbons, said first set of corrugated ribbons and said second set of corrugated ribbons adapted to maintain a spacing between said pair of opposing face sheets, said first set of corrugated ribbons and said second set of corrugated ribbons adapted to increase resistance of said panel to a reduction in spacing between said pair of opposing face sheets from a force applied to a surface of one of said pair of opposing face sheets, each ribbon of said second set of corrugated ribbons defining:
a longitudinal axis, each longitudinal axis of each ribbon of said second set of corrugated ribbons of said panel substantially perpendicular to each longitudinal axis of each ribbon of said first set of corrugated ribbons of said panel;
a length;
a height, said height of said second set of corrugated ribbons less than said length of said second set of corrugated ribbons;
a width, said width of said second set of corrugated ribbons less than said length of said second set of corrugated ribbons; and
a period, said length of said second set of corrugated ribbons greater than twice said period of said second set of corrugated ribbons;
said first set of corrugated ribbons and said second set of corrugated ribbons sandwiched between said pair of opposing face sheets, a raised portion of each ribbon of said first set of corrugated ribbons interlocking with a corresponding recessed portion of ribbons of second set of corrugated ribbons, via interaction with said raised portion of each ribbon of said first set of corrugated ribbons with said second set of corrugated ribbons, said second set of corrugated ribbons adapted to restrain motion of each of said first set of corrugated ribbons relative to said second set of corrugated ribbons:
in a direction that is substantially parallel to said longitudinal axes of each ribbon of said first set of corrugated ribbons; and
in a direction that is substantially parallel to said longitudinal axes of each ribbon of said second set of corrugated ribbons;
said panel, via said pair of opposing face sheets and said sets of corrugated ribbons, defining:
a first plurality of channels, each of which defines a longitudinal axis; and
a second plurality of channels, each of which defines a longitudinal axis, each longitudinal axis of each of said first plurality of channels substantially perpendicular to each longitudinal axis of each of said second plurality of channels, each of said first plurality of channels and said second plurality of channels adapted to transfer heat from said panel via a heat transfer fluid.
